(19) United States
(12) Patent Application Publication
(10) Pub. No.: US 2023/0216858 A1
(43) Pub. Date: Jul. 6, 2023

(54) DYNAMIC PERMISSIONS INTERFACE

(71) Applicant: Google LLC, Mountain View, CA (US)

(72) Inventors: Danting Chen, Munich (DE); Balazs Engedy, Munich (DE); Igor Bilogrevic, Cureglia (CH); Enrico Bacis, Thalwil (CH); Edward Jung, London (GB); Andy Paicu, Munich (DE); Ravjit Uppal, Munich (DE); Penelope McLachlan, Bowen Island (CA); Andrea Jorge, London (GB); Illia Klimov, Munich (DE)

(21) Appl. No.: 18/065,211

(22) Filed: Dec. 13, 2022

Related U.S. Application Data
(60) Provisional application No. 63/266,309, filed on Dec. 31, 2021.

(51) Int. Cl. H04L 9/40; G06F 3/0482; G06F 3/04817; G06F 3/0483; G06F 9/451

(52) U.S. Cl. CPC H04L 63/102; G06F 3/0482; G06F 3/04817; G06F 3/0483; G06F 9/451

(57) ABSTRACT

Systems and methods are disclosed for providing a dynamic user interface for managing resource permissions while using a browser. An example method includes determining that a user of the computing device has not blocked a permission for a resource and has not allowed the permission for the resource, the permission for the resource being requested by a website. The method may also include obtaining a permission score for the resource from a model, the permission score representing a likelihood of the user allowing use of the resource. The method may also include selecting a permissions interface element from one of a loud user interface element, a quiet user interface element, and an intermediate user interface element based on the permission score and generating a user interface on a display that includes the permissions interface element.

### CROSS-REFERENCE TO RELATED APPLICATION

This application is a non-provisional of, and claims the benefit of, U.S. Provisional Patent Application No. 63/266,309, filed on Dec. 31, 2021, entitled “DYNAMIC WEB PERMISSIONS INTERFACE,” the disclosure of which is incorporated by reference herein in its entirety.

### BACKGROUND

Websites often provide information or functionality helpful to users. While websites are conventionally authored using a markup language, many websites also make use of scripting languages to provide additional functionality and/or a better and more customized user experience. Scripting languages, such as JavaScript, can be used to access resources on a user's computing device.

### SUMMARY

Implementations provide a dynamic user interface for controlling resource permissions while using a browser. The dynamic user interface is configured to balance discoverability with interruption. To prevent malicious actors from using websites to gain access to resources on the user's computing device (e.g., through scripting languages), browsers can restrict access to these resources. Access to some or all of the user's local resources can be blocked by default. In such instances, access can only be given after the user has expressly allowed it (e.g., via a browser, an extension, an application, an organization, etc.). Preventing a website from using requested resources can break the functionality of a web site, but in some cases, prevention also protects the user's privacy and security. Because preventing all sites from accessing resources can adversely affect desired functionality and permitting all sites to access resources can adversely affect the user's privacy and computer security, a web browser or other user agent, when a webpage requests a resource, may display pop-up windows and the like to allow users to grant access to requested resources, e.g., so that the user can choose to expressly grant a permission to a particular webpage. But interruptive prompts for access, such as the pop-up windows, can be annoying and disruptive to the browsing experience. To avoid interruption, many browsers block the resource request without showing such interruptive prompts. The browser may provide an indication that a resource request was blocked using a quiet user interface element, e.g., one that is not very noticeable to the user (low interruption), so as not to interrupt the user's experience. However, if the website fails to function properly, the user may not know why because the indication is hard to discover due to the low interruption design.

Implementations provide a technical solution to the binary choice between frequent interruption of the user's experience and making the occasional grant of resource access difficult to accomplish. Specifically, implementations introduce a novel user interface and a specialized permissions model that work together to dynamically select one of multiple potential user interface elements when a website requests access to a resource on the user's computing device. The selection of the user interface element is based on the output of the permissions model. The permissions model is a machine-learned permissions model trained to predict the likelihood of a user granting the website's requested access to a particular resource. Input to the permissions model can include features describing the website requesting access to a resource, including features describing the website's historical pattern of resource grants. Input to the permissions model can include features describing the user's historical pattern of resource grants.

One or more of the implementations of the subject matter described herein can be implemented to realize one or more of the following technical advantages/technical effects. As one example, the permissions model enables a system to more intelligently provide access to resources, simplifying the interactions needed to grant access to a resource. As another example, implementations match the screen area (e.g., the amount of display space) devoted to the resource request to the likelihood of granting access to the resource. As another example, implementations reduce the interruption caused by permissions prompts while increasing the visibility of a blocked request, thus simplifying the browsing experience without unintentionally breaking desired functionality. Implementations provide a new user interface element that represents a middle ground between a disruptive (or loud) pop-up and a subtle background (or quiet) notification that can be difficult to notice or find, thus the new user interface element may be referred to as an intermediate user interface element. The intermediate user interface element may use animation to catch the eye of a user and/or be positioned closer to an area of the display corresponding to a reading start position, making the interface for granting a permission more discoverable.

The details of one or more implementations are set forth in the accompanying drawings and the description below. Other features will be apparent from the description and drawings, and from the claims.

### BRIEF DESCRIPTION OF THE DRAWINGS

FIG. 1 illustrates an example browser interface.

FIGS. 2A-2D illustrate example intermediate user interface elements for managing resource permissions, according to an aspect.

FIG. 3A illustrates an example quiet user interface element for managing resource permissions, according to an aspect.

FIG. 3B illustrates an example loud user interface element for managing resource permissions, according to an aspect.

FIG. 4 illustrates a system for providing a dynamic permissions interface, according to an aspect.

FIG. 5 is a flowchart depicting example operations for generating a model used in providing a dynamic permissions interface, according to an aspect.

FIG. 6 is a flowchart depicting example operations for presenting a dynamic permissions interface, according to an aspect.

FIG. 7 shows an example of example computing devices according to an aspect.

### DETAILED DESCRIPTION

Implementations relate to providing a permissions model that predicts a likelihood of a user granting a website access to a requested resource of the user's computing device. Implementations also relate to providing one or more less-intrusive but more noticeable user interface elements for notifying the user that a resource has been requested and providing the user quick access to privacy-based settings. These intermediate user interface elements represent a balance/spectrum between interruption and discovery. The intermediate user interface elements can have different properties that favor discovery or interruption. For example, an intermediate user interface element may appear closer to the beginning of a reading direction. A reading direction is language-based and represents how text in the language is read. For example, in English, the top left is the beginning of the reading direction. The beginning of the reading direction can be based on a browser setting language or a language of the displayed webpage. A permissions user interface element located at the beginning of the reading direction makes it more discoverable. As another example, an intermediate user interface element may include text and take up more screen area than a quiet user interface element, but may have less text and take up less screen area than a loud user interface element. The type and amount of text may vary, depending on the score for the requested resource.

An intermediate user interface element may displace another browser interface element, such as the search bar or text within the search bar. An intermediate user interface element may be an animated element. An animated user interface element uses animation to displace the other browser interface element. For example, an animation may cause the permissions interface element to grow in size while the other browser interface element shrinks in size. This (the animation) may attract the eye of the user, making the element discoverable, without requiring the user to interact with the element. An intermediate user interface element may have a different appearance than the other browser interface element. For example, the intermediate user interface element may have a different background color than other browser elements, may have a different font, font color, or a combination of these. In some implementations an intermediate user interface element may be temporary, e.g., may be displayed for a predetermined amount of time before being removed. In some implementations, an intermediate user interface element may have an initial state and an ending state. The initial state may be more visible (e.g., have more text, take up more area of the display, have a different appearance) than the ending state. In some implementations, the ending state may appear similar to or transition to the quiet user interface element.

Some implementations may use the output of a permissions model to determine which of the possible variations (elements) of the permissions user interface to present to the user. In some implementations, the user may select a provider of the model. The model may provide a permission score as the output. The permissions score represents the likelihood of the user granting access to the requested resource. The system uses the permissions score to trigger one of the possible user interfaces for obtaining a decision from the user. A loud user interface element is the most interruptive. A loud user interface element takes up the most area of the display. For example, a loud user interface element often overlays (covers up) a portion of the content displayed by the webpage. A pop-up window (including a modal window) is an example of a loud user interface; the user can grant permission, close the window, or can ignore the window (leaving it to cover/obscure some area of the display). This can be disruptive to the browsing experience, to the point of annoyance. Because of this, implementations may trigger the loud user interface element when the permission score indicates a high likelihood of the user granting permission (e.g., a low likelihood of the user not granting permission).

The other extreme of the potential interface options is a quiet user interface element. The quiet user interface element takes up the least area of the display. The quiet user interface element may lack text. The quiet user interface element may be configured with on-hover and on-click actions. For example, if a user hovers over a portion of the quiet user interface element, text explaining that the resource was blocked by default may appear. If a user clicks on a portion of the quiet user-interface element, this may trigger the loud user interface element or a pop-up similar to the loud user interface element where a user can expressly block or allow access to the resource or clear the window without making an express decision. The quiet user interface element is the least intrusive of the potential user interface elements. Because the quiet user interface element is the least intrusive it may be difficult to identify and may not be noticed by the user. Accordingly, implementations may trigger the quiet user interface element when the permission score indicates a low likelihood of the user granting permission (e.g., a high likelihood of the user blocking use of the resource).

Implementations may trigger the intermediate interface if the threshold for high likelihood of the user granting permission is not met and if the threshold for high likelihood of the user blocking permission is not met.

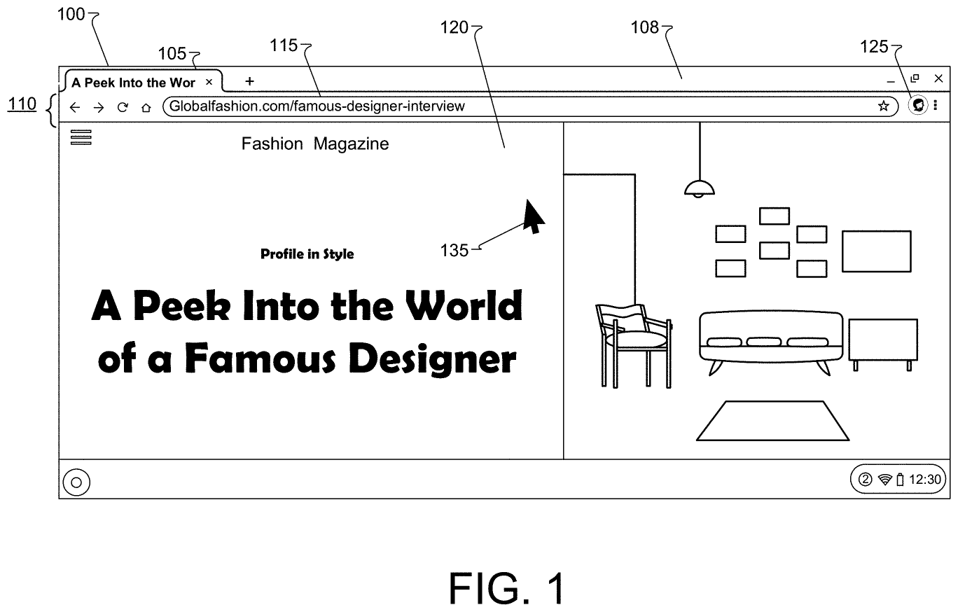

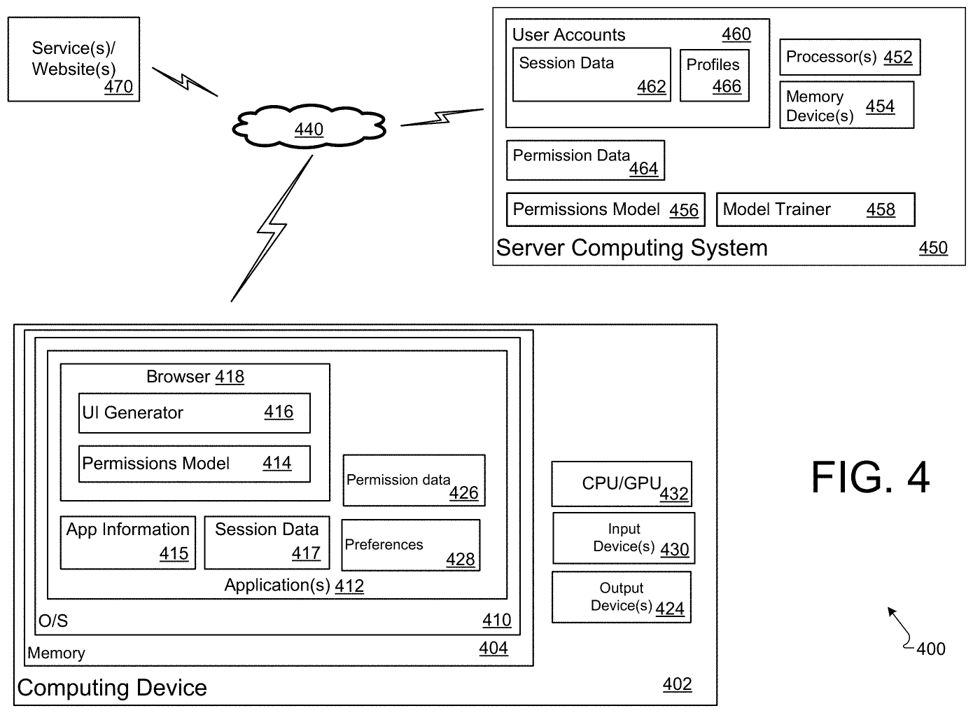

FIG. 1 illustrates an example browser interface (UI) 100, in accordance with implementations described herein. In general, the UI 100 is generated and rendered by a browser application (e.g., browser 418 of FIG. 4) executing in an operating system (e.g., operating system 410) of a computing device. The UI 100 includes a tab strip 108 associated with the browser application. In this example, the UI 100 includes a browser tab 105, although any number of browser tabs or tab groups can be opened by the browser application. Each browser tab, e.g., browser tab 105, may be associated with web content (a webpage) presented in a corresponding browser content window 120 of the browser application. As used herein, a webpage refers to any content generated/served at least partially by/from a server hosting a website. Thus, webpage can refer to a progressive web application in addition to conventional webpages.

The UI 100 also includes an address bar area 110. An address of the webpage displayed in the browser content window 120 can be illustrated in the address bar area 110 (e.g., input address area 115). Other controls, icons, and/or so forth can be included in the address bar area 110. For example, the address bar area 110 can include a user icon 125. The user icon 125 may provide an indication of a user account associated with the browser session. This user icon 125 can be an image, text, or some other representation of the user account. Other controls/icons conventionally included in the address bar area 110 include a forward control, a back control, a refresh control, a home control, an extensions control, and/or a bookmark control. The address bar area 110 can be controlled by and/or associated with the browser (e.g., the browser 418). The content of the address bar area 110 can be controlled by the browser application, whereas the content of the browser content window 120 is controlled by the webpage being displayed and/or a provider of the webpage. Thus, the appearance and user interface elements displayed in the address bar area 110 are controlled by the browser application.

In cases such as when the user interface does not display an address bar (e.g., in a progressive web application), the implementation may choose to a) show the loud or the quiet UI in its stead, b) ignore the permission request, c) temporarily reveal the address bar while the intermediate UI is shown, d) display the intermediate UI in a title bar or other existing element, or e) add an intermediate UI to a new bar, which may cause existing content to scroll.

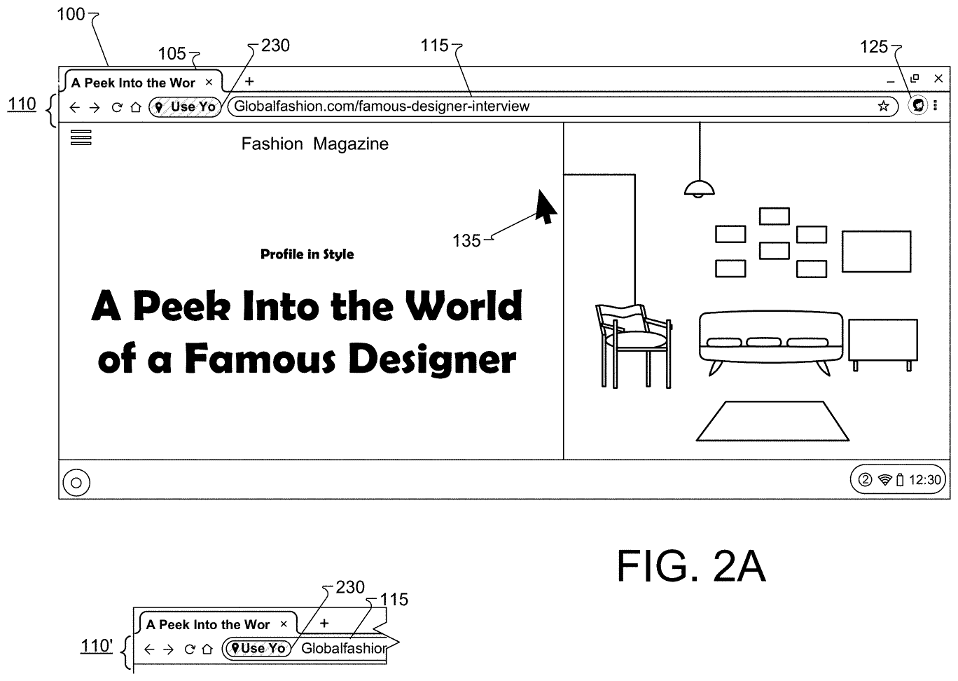

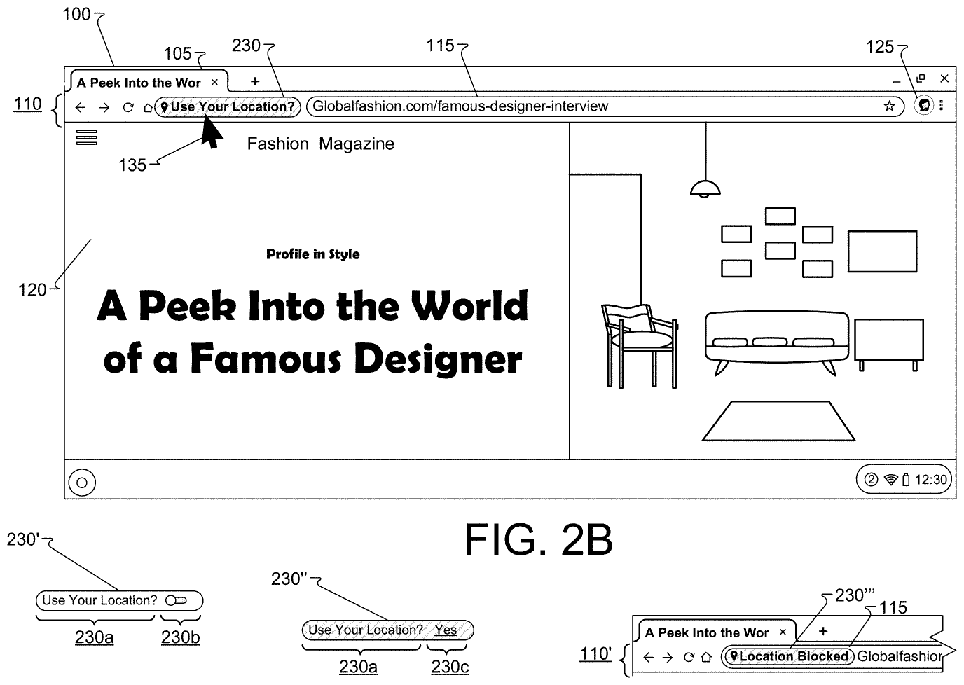

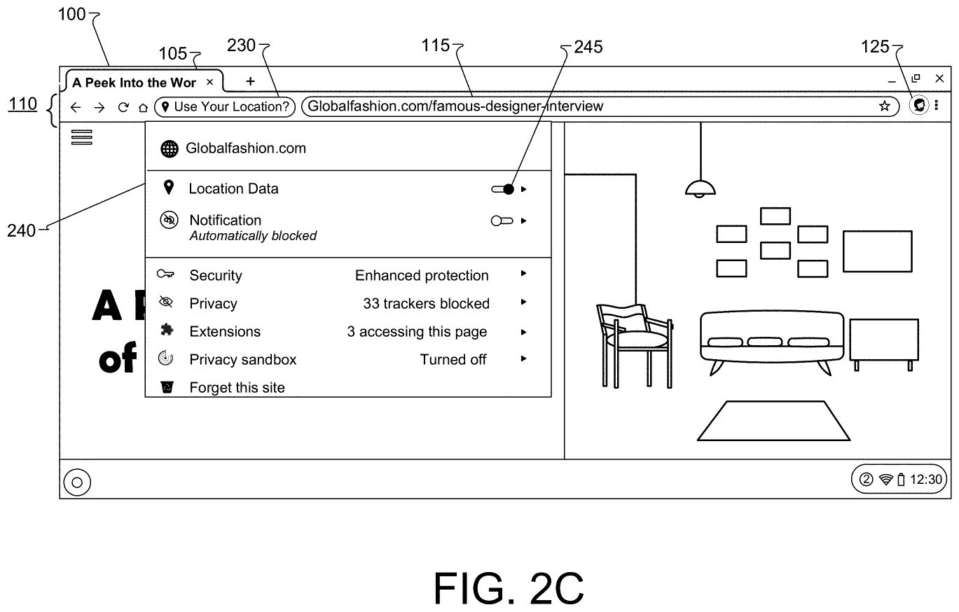

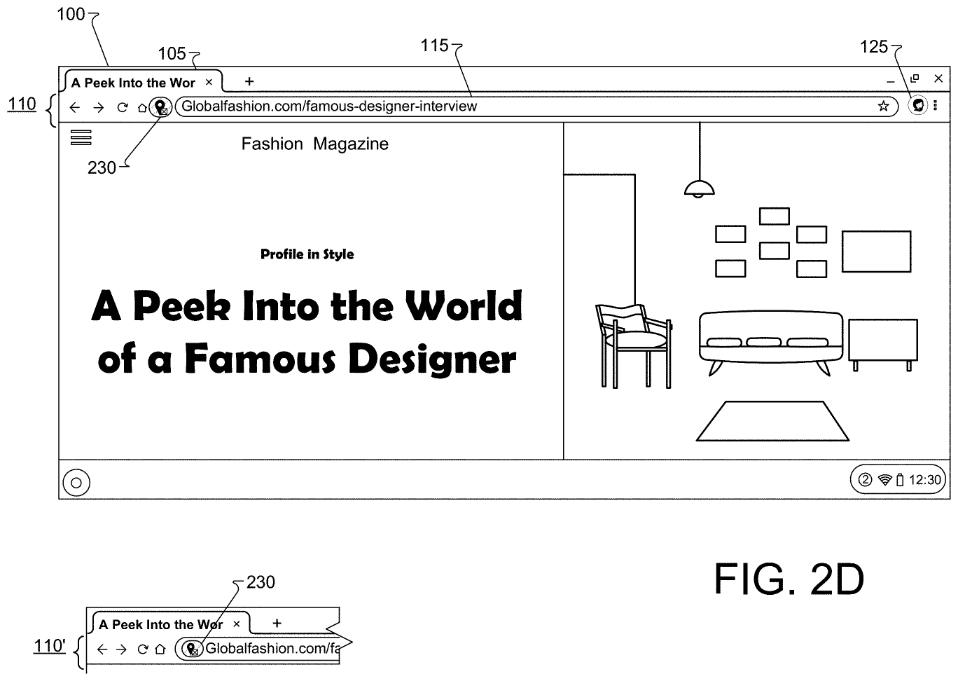

FIGS. 2A-2D illustrate examples of an intermediate user interface element 230 for managing permissions for a resource, according to an aspect. The browser application may trigger display of the intermediate user interface element 230 in response to loading the website identified in the input address area 115. The browser application may trigger display of the intermediate user interface element 230 in response to a request by the website for access to a resource located on the user's computing device. Requested resources can include access to location information, access to a camera, access to stored information, such as images (pictures), contacts, documents, etc., access to writeable storage, e.g., to write information about user interactions with the website, or any other resources included/managed by the user's device. In some implementations, the browser application may trigger display of the intermediate user interface element 230 if a predetermined amount of time has elapsed since the last time the intermediate or loud user interface was triggered. In some implementations, the browser application may use the output of a permissions model to determine whether to trigger display of the intermediate user interface element 230. For example, if a permissions score obtained from the permissions model does not meet a likely threshold and does not meet an unlikely threshold (e.g., is too low for the likely threshold and too high for the unlikely threshold where a higher score indicates higher likelihood) the browser application may trigger display of the intermediate user interface element 230.

The intermediate user interface element 230 may be placed in the address bar area 110. The intermediate user interface element 230 may be placed on a left-hand side of the address bar area 110 when a language associated with the user (e.g., the user represented by user icon 125) and/or the language of the webpage displayed in the browser content window 120 has a left-to-right reading order. For languages that have a right-to-left reading order the intermediate user interface element 230 may be placed in the right-hand side of the address bar area 110. In some implementations, the intermediate user interface element 230 may have a different appearance (represented by diagonal lines) than other user interface elements in the address bar area 110. For example, the intermediate user interface element 230 may have a different text color, a different background color, a different font, and/or a different font size, etc. In some implementations, the user interface element 230 may be located within the input address area 115, e.g., as illustrated in address bar area 110′ of FIG. 2A. In such implementations the text of the address displayed in the address area 115 may be displaced by the intermediate user interface element 230.

In the example of FIG. 2A the intermediate user interface element 230 is animated. In other words, display of the intermediate user interface element 230 includes displaying the expansion of the intermediate user interface element 230 and the shrinking of another browser element, such as the input address area 115, to make room for the intermediate user interface element 230. In FIG. 2A the intermediate user interface element 230 is displayed part-way through the animation. FIG. 2B illustrates an example of the intermediate user interface element 230 after the animation has ended, or in other words in a final state. In the example of FIG. 2B, the intermediate user interface element 230 is fully expanded (in a maximal state) and the input address area 115 has shrunk in size. In other words, the input address area 115 takes up less area of the display than it did before the display of the intermediate user interface element 230. In some implementations, the browser element that shrinks (e.g., input address area 115) is animated and the intermediate user interface element is displayed in the area previously occupied by the input address area 115. Although the input address area 115 is illustrated as the browser interface element that shrinks, another browser interface element may be the user interface element that makes room for the intermediate user interface element 230. For example, in implementations where the intermediate user interface element 230 is included in the input address area 115, the text of the address may be displaced as illustrated by address bar area 110′ illustrated in FIG. 2B. Implementations can include displacement of other browser elements.

The intermediate user interface element 230 includes text that provides an indication of the resource that the website requested access to. In some implementations, the intermediate user interface element 230 may include an icon associated with the requested resource. In the example of FIG. 2B the intermediate user interface element 230 includes characters and an icon representing location data. Intermediate user interface element 230′″ represents another example with text that provides an indication of the resource the website requested access to. These are provided as examples only and the text displayed by an intermediate user interface element 230 can include any characters and/or icons providing an indication of or identification of the resource requested by the website. In some implementations, the intermediate user interface element 230 may include text and an actionable area. For example, intermediate user interface element 230′ includes text 230a and a slider control 230b. In another example, intermediate user interface element 230″ includes text 230a and a link 230c. The slider control 230b and the link 230c both represent an actionable area. An actionable area is configured to respond to an on-click event (or the like). In other words, the user can interact with the actionable area, e.g., by clicking on/selecting the actionable area. The actionable area may be configured to interpret the interaction as express consent for the website to access the requested resource. Thus, for example, if the user clicks on the slider control 230b the browser may interpret that interaction as express permission for the website displayed in the browser content window 120 to access the requested resource.

The intermediate user interface element 230 may be configured to trigger display of a privacy settings user interface, such as the privacy settings user interface 240 of FIG. 2C. Thus, for example, the text 230a may be an actionable area that, when selected using an input device (such as cursor 135) may trigger display of the privacy settings user interface 240. The privacy settings user interface 240 may include a summary of the permissions for the website displayed in browser content window 120. The privacy settings user interface 240 may be removed from display in response to the user clicking outside of the privacy settings user interface window. The privacy settings user interface 240 may include controls, such as control 245, for granting or blocking the website from accessing specific resources. In some implementations, the privacy settings user interface 240 may include controls for accessing other privacy settings, improving the discoverability of such settings.

In some implementations, the intermediate user interface element 230 may be displayed in its maximal state (fully expanded) for a predetermined amount of time. For example, after the predetermined amount of time (e.g., 30 seconds, a minute, two minutes, etc.) the browser application may remove the intermediate user interface element 230. Removal would take the browser user interface element that shrunk (e.g., input address area 115) back to its original size (e.g., as illustrated in FIG. 1). In some implementations, the intermediate user interface element 230 may shrink to a minimal state after the predetermined time, as illustrated in FIG. 2D. In some implementations, this may be animated. In some implementations, the intermediate user interface element 230 in the minimal state may appear similar to the appearance of the quiet user interface element. For example, a similar icon and size may be used and the intermediate user interface element 230 may lose associated text. In some implementations, the intermediate user interface element 230 may keep its different appearance (e.g., different background color). In some implementations (not shown), the browser application may remove the intermediate user interface element 230 from the display after the predetermined time and trigger display of the quiet user interface element.

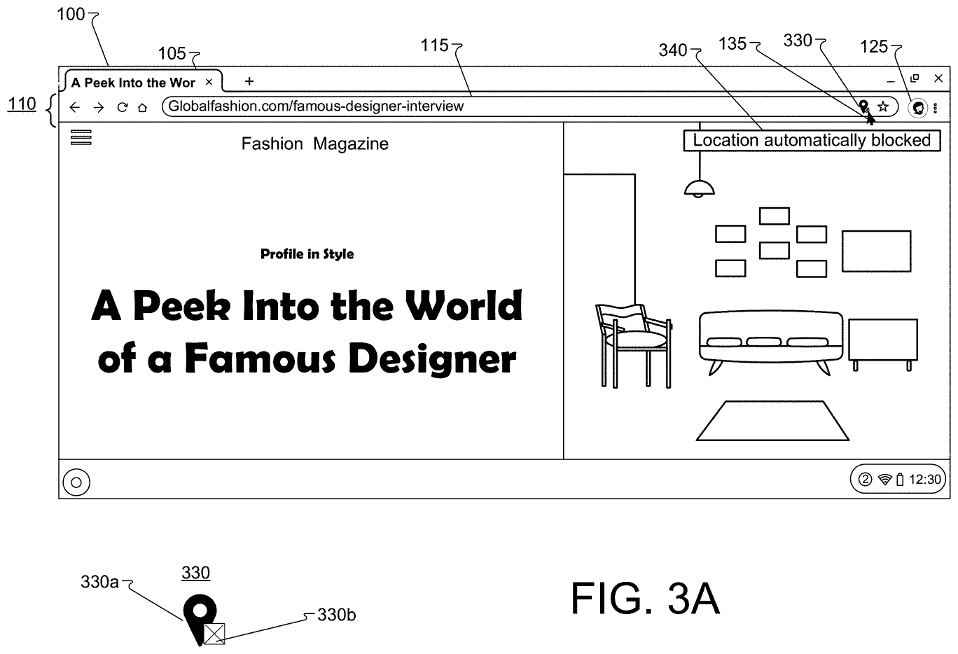

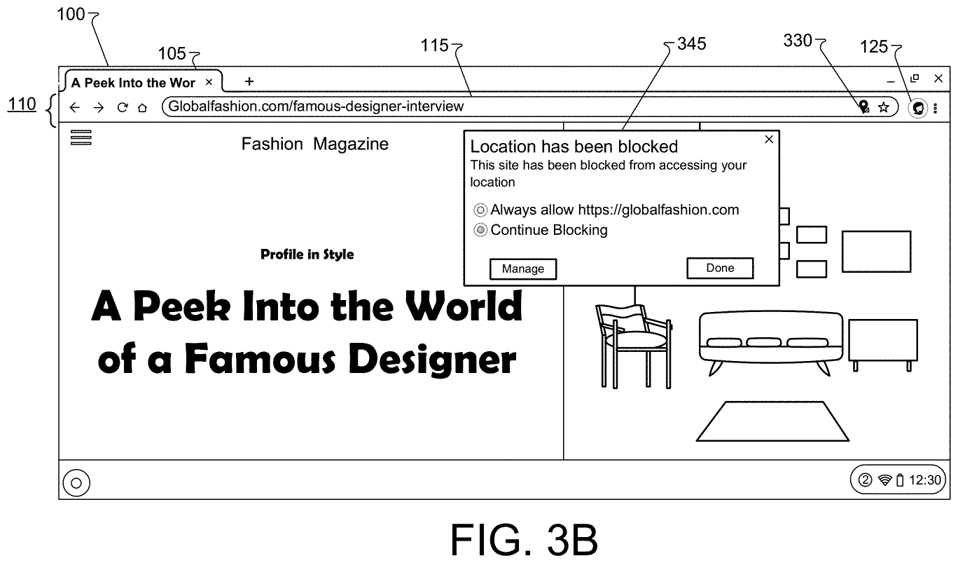

FIG. 3A illustrates an example quiet user interface element 330 for managing resource permissions, according to an aspect. The browser application may trigger display of the quiet user interface element 330 in response to a request by the website for access to a resource located on the user's computing device and in response to determining that the output of a permissions model indicates the user is unlikely or very unlikely to grant permission. Put another way, if a permissions score obtained from the permissions model meets (satisfies) an unlikely threshold (e.g., indicating the user is unlikely to grant access) the browser application may trigger display of the quiet user interface element 330. The unlikely threshold represents the decision point for determining whether the user is unlikely or very unlikely to grant permission.

The quiet user interface element 330 may appear on an opposite side of the display from the intermediate user interface element 230. In some implementations, the quiet user interface element 330 may appear in the input address area 115. In some implementations, the quiet user interface element 330 may be positioned just after the input address area 115. The quiet user interface element 330 may initially lack text. Thus, the quiet user interface element 330 takes up less display area than the intermediate user interface element 230. The quiet user interface element 330 may include an icon or image 330a representing the resource requested and an icon or image 330b indicating that access to the requested resource is blocked. The quiet user interface element 330 may be configured to respond to an on-hover and/or an on-click event. For example, if the user places an input device (e.g., cursor 135) over a portion of the quiet user interface element 330, pop-up text 340 may be displayed. The pop-up text 340 may provide an indication that access to the requested resource (e.g., location) has been automatically blocked. If the user selects (clicks-on) the portion of the quiet user interface element 330, a permissions window may be displayed that enables the user to allow access or to continue blocking access to the requested resource. This permissions window can be similar to the loud user interface element.

FIG. 3B illustrates an example loud user interface element 345 for managing resource permissions, according to an aspect. The browser application may trigger display of the loud user interface element 345 in response to a request by the website for access to a resource located on the user's computing device and in response to determining that the output of a permissions model indicates the user is likely or very likely to grant permission. Put another way, if a permissions score obtained from the permissions model meets (satisfies) a likely threshold the browser application may trigger display of the loud user interface element 345. The likely threshold represents the decision point for determining whether the user is likely or very likely to grant permission.

The loud user interface element 345 may occupy more display area than the intermediate user interface element 230. The loud user interface element may be positioned over (obscuring) content in the browser content window 120. Thus, the loud user interface element 345 is more disruptive than the intermediate user interface element 230. In some implementations, the quiet user interface element 330 may appear in the input address area 115. The loud user interface element 345 includes more information, including more text and controls, than the intermediate user interface element 230. The loud user interface element 345 may include controls for expressly allowing the website to access the requested resource and for expressly blocking the website from accessing the requested resource. These express selections can be saved, e.g., as part of a user's profile (e.g., in permission data 426, permission data 464, and/or one of profiles 466), as part of session data (e.g., session data 417 and/or session data 462), and/or as part of application data for the browser (e.g., app information 415). If a site is expressly blocked or expressly allowed, the loud, intermediate, and quiet user interfaces are unnecessary and the browser application (e.g., browser 418) uses these express instructions to block or allow access. The loud user interface element 345 may include a control for closing (removing) the pop-up user interface element. Closing the pop-up user interface element does not result in any express instructions from the user. Thus, for example, the browser application may ask, using one of the loud, intermediate, or quiet user interface elements, whether the website can access the requested resource the next time the user visits the site.

In case the website requests permissions to multiple resources, some implementations may queue those requests and display them one-at-a-time. Some implementations may start with the first one in chronological order. Some implementations may start with the last one in chronological order. Some implementations may start with a highest ranked request, e.g., as decided by the browser application or by the requesting page. Some implementations may group two or more permission requests, such as the permissions to use the camera and the microphone.

FIG. 4 illustrates a system 400 for providing a dynamic permissions interface, according to an aspect. The system 400 can be used, for example, to produce any of the interfaces illustrated in FIGS. 1 to 3B. The system 400 includes a computing device 402 associated with a user, e.g., a personal computer, a laptop computer, a mobile phone, a tablet, a smart watch or other wearables, a smart television, and the like. In some examples, the computing device 402 is in communication with a server computing system 450 and/or services/websites 470 that provide content for display in a browser 418. The system 400 may be configured to provide a dynamic permissions interface, in accordance with permission data 426, preferences 428, and/or session data 417, 462.

The computing device 402 may include one or more processors 432 formed in a substrate configured to execute one or more machine executable instructions or pieces of software, firmware, or a combination thereof. The processors 432 can be semiconductor-based—that is, the processors can include semiconductor material that can perform digital logic. The computing device 402 may include memory 404. The memory 404 may include a main memory that stores information in a format that can be read and/or executed by the processors 432. The memory 404 may include other types of memory that store applications or modules (e.g., operating system 410, applications 412, etc.) that, when executed by the processors 432, perform certain operations.

The operating system (O/S) 410 is a system software that manages computer hardware, software resources, and provides common services for computing programs. In some examples, the operating system 410 is operable to run on a personal computer such as a laptop, netbook, or a desktop computer. In some examples, the operating system 410 is operable to run a mobile computer such as a smartphone, tablet, or a wearable device (glasses, goggles, watch, etc.). The operating system 410 may execute and or otherwise manage applications 412 based on app information 415 and/or session data 417. The O/S 410 may function to execute and/or control applications 412, UI interactions, accessed services, and/or device communications that are not depicted in FIG. 4. For example, the O/S 410 may allow a browser 418 to use resources of the computing device 402 to execute browser functionality. In some implementations, the use of these resources may be in accordance with one or more permissions in permission data 426. In some implementations, browser functionality (e.g., browser 418) is integrated into the O/S 410.

In some examples, the computing device 402 may communicate with a server computing system 450 over a network 440. In some examples, the server computing system 450 stores user accounts 460 for users of the various computing devices (e.g., such as computing device 402) of the system 400. A user account of the user accounts 460 may store information pertaining to the user, such as a profile 466 of the user and/or information obtained through the user's use of the computing device 402 such as session data 462, when authorized by the user. In some implementations, the session data 462 is updated from session data 417 for that user. For the browser 418 the session data 417 may represent the open browser tabs and browser windows during a single login to the browser 418. Sessions may be saved and reopened after closing or rebooting the computing device 402 executing the browser 418.

In some examples, although not shown in FIG. 4, the computing device 402 stores one or more of the user accounts 460 that pertain to the authorized user/users of the computing device 402, or in other words user accounts of users associated with the computing device 402. In some implementations, information from a user account (e.g., one of the user accounts 460) is synchronized with the computing device 402. For example, a user may indicate that the user authorizes user profile data, permission data, and/or session data, including session data 417, permission data 426 and/or preferences 428, to be used to update the user's account (e.g., in user accounts 460). In some implementations, the user account can be a browser profile. In some implementations, one of session data 417, preferences 428, and/or permission data 426 is not shared with server computing system 450.

For example, a user of the computing device 402 may be provided with controls allowing the user to make an election as to both if and when systems, programs, or features described herein may enable collection of user information (e.g., information about a user's activities or preferences, including session data 417, preferences 428, and/or permission data 426), etc.), in addition to if and when such information is used. Implementations may also enable a user to make an election of whether and what information is synchronized with the server computing system 450. Implementations may also treat certain data in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the computing device 402 may have control over what information is collected about the user, how that information is used, and what information is provided to the user and/or to the server computing system 450.

The server computing system 450 may be a computing device or computing devices that take the form of a number of different devices, for example a standard server, a group of such servers, or a rack server system. In some examples, the server computing system 450 may be a single system sharing components such as processors and memories. The network 440 may include the Internet and/or other types of data networks, such as a local area network (LAN), a wide area network (WAN), a cellular network, satellite network, or other types of data networks. The network 440 may also include any number of computing devices (e.g., computer, servers, routers, network switches, etc.) that are configured to receive and/or transmit data within network 440. Network 440 may further include any number of hardwired and/or wireless connections.

The server computing system 450 may include one or more processors 452 formed in a substrate, an operating system (not shown) and one or more memory devices 454. The memory devices 454 may represent any kind of (or multiple kinds of) memory (e.g., RAM, flash, cache, disk, tape, etc.). In some examples (not shown), the memory devices 454 may include external storage, e.g., memory physically remote from, but accessible by, the server computing system 450. The server computing system 450 may include one or more modules or engines representing specially programmed software. For example, the server computing system 450 may include a model trainer 458 that trains (generates) a permissions model 456 that determines (e.g., predicts with a corresponding confidence score) a likelihood that the user will allow a webpage to have access to a requested resource (e.g., any resource managed by the computing device 402, including information about the computing device 402 such as location information, input-output devices such as a camera, stored information and writeable storage, which may include images (pictures), contacts, documents, data for a website, etc.)

As shown in FIG. 4, the applications 412 of the computing device 402 includes the browser 418. The browser 418 represents a web browser configured to access information on the Internet. The browser 418 may launch one or more browser processes (not shown) to generate, render, and/or otherwise display browser content (e.g., webpages, documents, etc.). The browser 418 may also generate search history data, including permission data 426, and/or perform other browser-based operations. The browser 418 may also store data about browser sessions in session data 417, including tabs/tab groups, browser history (with user permission), and preferences 428.

As a user browses the Internet, or in other words accesses content/visits webpages/views documents, a webpage may request access to a resource of the computing device 402. Disclosed implementations may include a module, such as UI generator 416. As shown in FIG. 4, the browser 418 includes a UI generator 416 that functions to generate user interface elements as part of a browser frame or webpage. The user interface elements can include chips, windows, pop-up boxes, etc. and may change the browser interface, e.g., the address bar, depending on the element selected for display.

The UI generator 416 may provide different types of user interface elements for responding to such a request. For example, the browser 418 (e.g., browser 418, UI generator 416, or another browser component) may use a permissions model, such as permissions model 414, to determine how to respond to the request. The permissions model 414 is a machine-learned model that has been trained to predict a likelihood that the user will grant the requesting webpage access to the requested resource. In some implementations, a machine-learned model, such as permissions model 414, includes one or more neural networks. In some implementations the permissions model 414 may be one of: a machine learning model, a classifier, and a regression model. The likelihood output by the permissions model 414 may be expressed as a permissions score. The permissions score represents a value within a range that represents the likelihood. The range may have a first value that represents very low confidence that the user will permit access (e.g., a zero value, representing no confidence that the user will permit access) and a second value that represents very high confidence (close to certainty) that the user will permit access (e.g., a value of 1 or 100, etc.). The permissions score is a value between the first value and the second value. In some implementations, the permissions score can be expressed as a category or label based on the likelihood. For example, some implementations may split the range between the first value and the second value into portions, e.g., two portions, three portions, four portions, five portions, etc., and assign a label to each portion. The portions do not need to represent equal divisions of the range between the first value and the second value.

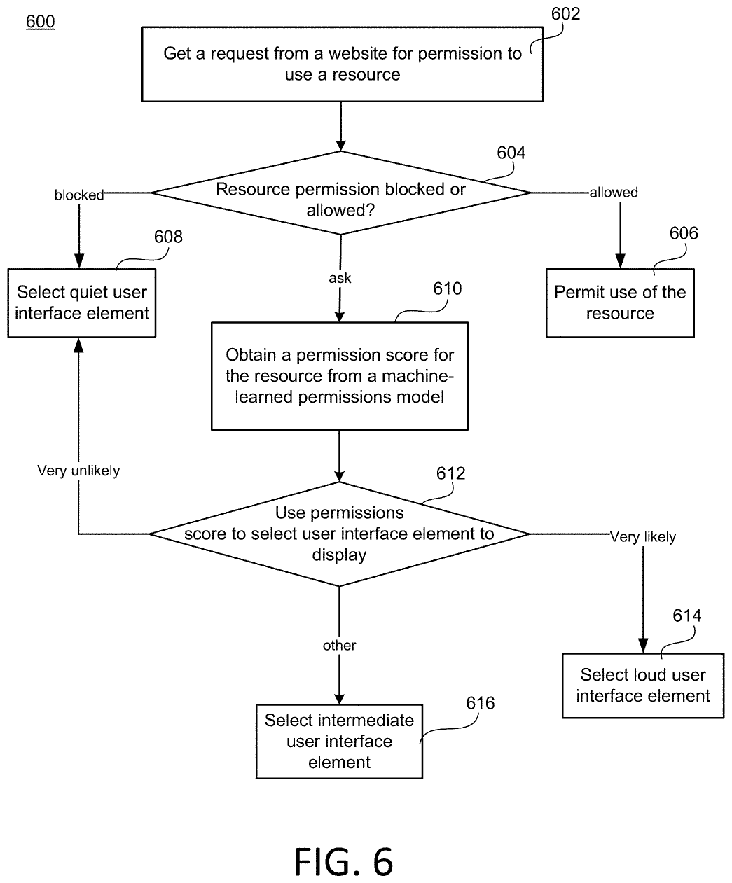

Depending on the output of the permissions model 414 (the permissions score), the browser 418 (e.g., UI generator 416) may select or trigger display of one of a number of user interface elements for responding to the request, as disclosed herein and described in more detail below with regard to FIG. 6. Thus, the permissions model 414 may perform inference operations. An inference operation uses the permissions model 414 to make a decision (provide a prediction) given an input. Thus, an inference operation makes (or leads to) one or more predictions.

In some implementations, the permissions model 414 may perform training operations. A training operation adjusts the model (e.g., the weights of the model) using new training data. In some implementations, the permissions model 414 can be trained/re-trained on permission data 426. In some implementations, the permissions model 414 may be a copy of permissions model 456, which may be trained on a larger set of data, e.g., permission data 464. In some implementations, the permissions model 414 may be updated, periodically, based on permissions model 456.

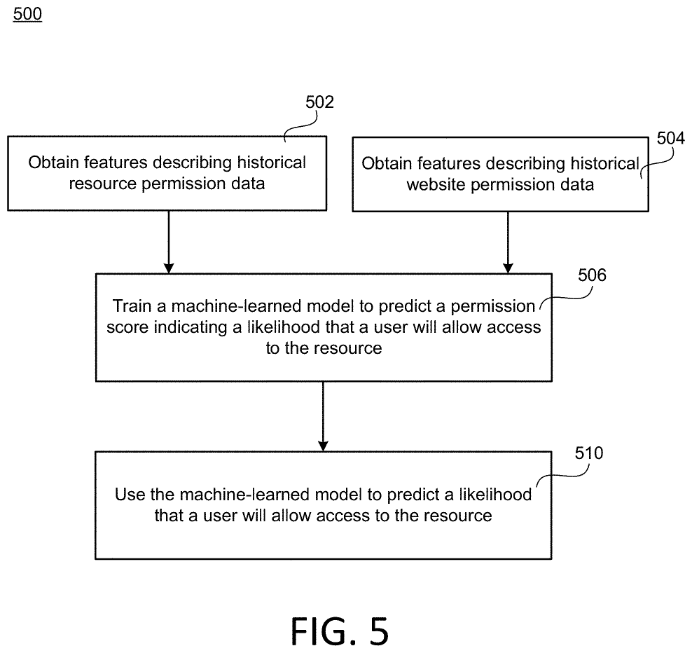

The permission data 464 may represent historical resource permission data from various users who explicitly authorize such data may be collected, e.g., to improve machine learned models such as the permissions model 456. The permission data 464 may include data describing/related to signals relating to explicit grants for access to a requested resource and explicit denials of access to a requested resource, as described in more detail with regard to FIG. 5. In such an implementation, the server computing system 450 may include a model trainer 458, which may be configured to train the permissions model 456 using permission data 464. The model trainer 458 may also be configured to update the permissions model 456, e.g., with more recently collected permission data 464. The permission data 426 includes information similar to that described with respect to permission data 464, but only includes data for users of the computing device 402.

In addition, the computing device 402 may also include or have access to input devices 430, and/or output devices 424. The input devices 430 may provide data to computing device 402, for example, received via a touch input device that can receive tactile user inputs, a keyboard, a mouse, a hand controller, a mobile device (or other portable electronic device), a microphone that can receive audible user inputs, a camera, and the like. The output devices 424 may include, for example, devices that generate content for a display for visual output, a speaker for audio output, and the like. The input devices 430, the output devices 424, and app information 415 (e.g., contacts data base, calendar information, file locations, etc.) are examples of resources that a webpage may request access to.

FIG. 5 is a flowchart depicting an example process 500 for generating a permissions model used in providing a dynamic permissions interface, according to an aspect. Process 500 may be performed by a computing system, such as server computing system 450 of FIG. 4, and may generate a trained model, such as permissions model 456 of FIG. 4. In some implementations, the permissions model can be pushed to a user's device, e.g., permissions model 414 of FIG. 4.

Process 500 begins by obtaining features describing historical resource permission data. The historical resource permission data (e.g., permission data 464 of FIG. 4) includes features describing past actions of the user, e.g., actions already taken in response to permission prompts by the user. For example, the features related to past actions can include data describing/related to signals relating to explicit grants for access to a requested resource and/or explicit denials of access to a requested resource. In some implementations, the historical resource permission data may include data describing/related to implicit approval of automatic blocking of access to the request, which are also examples of features about past actions related to permission prompts. An example of implicit approval of an automatic block includes a user cancels out of a loud permissions user interface element without explicitly blocking or explicitly granting access. The historical resource permission data may include signals describing an environment in which an explicit or implicit resource decision (grant/block) is made. Signals can include the type of operating system in use on the client device, the form factor of the client device (e.g., a display area, whether the device is mobile phone, desktop, notebook, netbook, wearable, etc.), gestures that occurred before the user interface element (prompt) that resulted in the resource request, the website or domain requesting the resource, and the like. These environment signals can also be features describing past actions of the user, as they give context to the past actions. Some implementations may include such data about other resources (not just the requested resource). Some implementations may weight the training data so that recent decisions (training examples) are weighted higher than older decisions (e.g., using a decay). The historical resource permissions data (e.g., permission data 464) may be obtained from users who explicitly indicate that such data may be collected, e.g., to improve machine learned models such as the permissions model.

In some implementations, the system may obtain features describing historical website permission data (504), or in other words features about the website. The features about the website can be included in the permission data (e.g., permissions data 464). The features describing historical website permission data include average or aggregate resource decisions for websites. The features describing the website can include aggregate statistics representing the number of times the resource permission is blocked and/or allowed for the website. In some implementations, the aggregate statistics may account for whether the grant is a one-time grant or an “always” grant. The features describing the website can include time spent on a website, general behavior on the website (not connected to granting resource permission), etc. In some implementations, the features can include features related to search ranking signals, such as Page Rank, etc.

The system may use the features to train the permissions model to predict a permissions score (506). The permissions score reflects the likelihood that the user will expressly grant or deny access to the requested resource. The permissions score can be a number. The number may represent a likelihood on a scale (e.g., scale from zero to one, from zero to 100, zero to ten, etc.). The number may be a tertiary value, e.g., one value indicating the user is likely/very likely to grant, one value indicating the user is unlikely/very unlikely to grant, and a default value (e.g., not likely to grant or block). The permissions score can be two flags, one flag indicating whether the user is likely/very likely to grant access and another flag indicating whether or not the user is unlikely/very unlikely to block access. The training may be supervised or semi-supervised. For example, the explicit resource decision (grant or block) may be considered the label for the training data. An implicit block may be considered a label for blocking the access, but may have a lower weight than a label for explicit blocking. Once trained, the permissions model can be used to predict a likelihood that a user will allow access to a requested resource (510), as described herein. The permissions model can be tuned/retrained at step 506 from time to time using updated historical permission data (e.g., historical resource permission data and/or historical website permission data). If the permission model is pushed to user devices, the updated model may be pushed to the devices.

FIG. 6 is a flowchart depicting an example process 600 for presenting a dynamic permissions interface, according to an aspect. The process may be performed by a user's device (e.g., a browser application executing on the user's device) in response to a request by a website for permission to access/use a resource of the user's computing device. The method 600 includes receiving the request for the resource (602). The device may determine whether or not the requested resource is blocked or allowed (604). If the user has expressly allowed the website to have access to the resource, the website is permitted access (606) and process 600 ends. Express permission may be recorded in a user profile, in session information, and/or in application information. If the user has expressly blocked the user interface element, the website is not allowed to use the resource. In some implementations, this may trigger display of the quiet user interface (608). If the user has neither expressly blocked nor expressly allowed access to the resource by the website the device may ask the user whether to allow or block access. In some implementations, where a permissions model is not used, this may be done using the intermediate user interface element (616). The intermediate user interface element 616 is illustrated in FIGS. 2A-2D.

In implementations that use a permissions model, the device may obtain a permission score for the resource from the permissions model (610). The permissions model can take several features as input (e.g., the features used to train the model, as described in more detail with regard to FIG. 5) and provide a score as output. In some implementations, the permissions model may be a service accessed using an application program interface (API). In some implementations, the user may select a provider of the permissions model. In other words, permissions models may be offered by two or more providers and the user, e.g., via browser settings, may be able to select the provider. In some implementations the service may be remote, e.g., on a server. In some implementations, the service may be local, e.g., the model is stored and accessed locally. The device uses the permission score to select one of three permissions user interface elements. The permissions score can be a numerical score, e.g., representing a predicted likelihood of the user granting access to the requested resource. In such implementations, the device compares the permissions score to a likely threshold and/or an unlikely threshold. If the permission score satisfies the likely threshold, the device may select the loud user interface element (614). FIG. 3B illustrates an example of the loud user interface element. If the permission score satisfies the unlikely threshold, the device may select the quiet user interface element (608). FIG. 3A illustrates an example of the quiet user interface element. If neither the permission score fails to satisfy the likely threshold and fails to satisfy the unlikely threshold, the device may select the intermediate user interface element for display (616). In some implementations the permissions score is one of three values, the first representing a prediction that the user is very unlikely to grant access, a second representing a prediction that the user is very likely to grant access, and a third value (a default value) indicating the predicted likelihood is neither very likely nor very unlikely. In some implementations, the permissions score (output of the model) is a binary value for the very unlikely prediction and a binary value for the very likely prediction and the device can determine from these two values which of the permission user interface elements to show. Although illustrated with three permissions user interface elements, implementations can operate with multiple versions of the intermediate user interface element, e.g., some being more disruptive and some being less disruptive. The permissions score can be used to select one of the multiple possible permissions user interface elements. As one example, an intermediate user interface element may have more text if the permissions score indicates the user is more likely to grant access and less text if the permissions score indicates the user is not as likely to grant access. Similarly, the appearance of the intermediate user interface element, the location of the element, the amount of time the full element is displayed, etc. can be based on the permissions score. In some implementations, one or more of the properties (e.g., amount of text, appearance, location, animation, time displayed, etc.) of the intermediate user interface element may be customizable by the user. Process 600 ends, for this visit to the website.

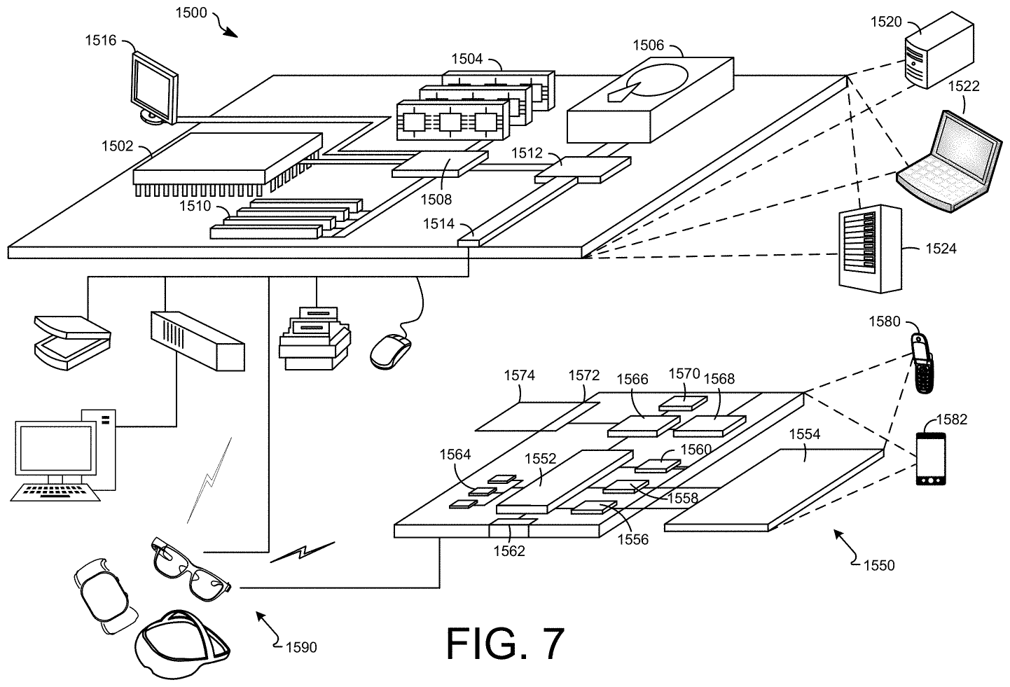

FIG. 7 shows an example of example computing devices according to an aspect. In some implementations, the computer device 1500 is an example of the computing device 402. In some implementations, the computer device 1500 is an example of the server computing system 450. In some implementations, the mobile computer device 1550 is an example of the computing device 402. Computing device 1500 is intended to represent various forms of digital computers, such as laptops, desktops, tablets, workstations, personal digital assistants, televisions, servers, blade servers, mainframes, and other appropriate computing devices. Computing device 1550 is intended to represent various forms of mobile devices, such as personal digital assistants, cellular telephones, smart phones, and other similar computing devices. The components shown here, their connections and relationships, and their functions, are meant to be examples only, and are not meant to limit implementations of the implementations described and/or claimed in this document.

Computing device 1500 includes a processor 1502, memory 1504, a storage device 1506, a high-speed interface 1508 connecting to memory 1504 and high-speed expansion ports 1510, and a low speed interface 1512 connecting to low speed bus 1514 and storage device 1506. The processor 1502 can be a semiconductor-based processor. The memory 1504 can be a semiconductor-based memory. Each of the components 1502, 1504, 1506, 1508, 1510, and 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as display 1516 coupled to high speed interface 1508. In other implementations, multiple processors and/or multiple buses may be used, as appropriate, along with multiple memories and types of memory. Also, multiple computing devices 1500 may be connected, with each device providing portions of the necessary operations (e.g., as a server bank, a group of blade servers, or a multi-processor system).

The memory 1504 stores information within the computing device 1500. In one implementation, the memory 1504 is a volatile memory unit or units. In another implementation, the memory 1504 is a non-volatile memory unit or units. The memory 1504 may also be another form of computer-readable medium, such as a magnetic or optical disk.

The storage device 1506 is capable of providing mass storage for the computing device 1500. In one implementation, the storage device 1506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1504, the storage device 1506, or memory on processor 1502.

The high speed controller 1508 manages bandwidth-intensive operations for the computing device 1500, while the low speed controller 1512 manages lower bandwidth-intensive operations. Such allocation of functions is an example only. In one implementation, the high-speed controller 1508 is coupled to memory 1504, display 1516 (e.g., through a graphics processor or accelerator), and to high-speed expansion ports 1510, which may accept various expansion cards (not shown). In the implementation, low-speed controller 1512 is coupled to storage device 1506 and low-speed expansion port 1514. The low-speed expansion port, which may include various communication ports (e.g., USB, BLUETOOTH, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. It may also be implemented as part of a rack server system 1524. In addition, it may be implemented in a personal computer such as a laptop computer 1522. Alternatively, components from computing device 1500 may be combined with other components in a mobile device (not shown), such as device 1550. Each of such devices may contain one or more of computing devices 1500, 1550, and an entire system may be made up of multiple computing devices 1500, 1550 communicating with each other.

Computing device 1550 includes a processor 1552, memory 1564, an input/output device such as a display 1554, a communication interface 1566, and a transceiver 1568, among other components. The device 1550 may also be provided with a storage device, such as a microdrive or other device, to provide additional storage. Each of the components 1550, 1552, 1564, 1554, 1566, and 1568, are interconnected using various buses, and several of the components may be mounted on a common motherboard or in other manners as appropriate.

The processor 1552 can execute instructions within the computing device 1550, including instructions stored in the memory 1564. The processor may be implemented as a chipset of chips that include separate and multiple analog and digital processors. The processor may provide, for example, for coordination of the other components of the device 1550, such as control of user interfaces, applications run by device 1550, and wireless communication by device 1550.

Processor 1552 may communicate with a user through control interface 1558 and display interface 1556 coupled to a display 1554. The display 1554 may be, for example, a TFT LCD (Thin-Film-Transistor Liquid Crystal Display) or an OLED (Organic Light Emitting Diode) display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may be provided in communication with processor 1552, so as to enable near area communication of device 1550 with other devices. External interface 1562 may provide, for example, for wired communication in some implementations, or for wireless communication in other implementations, and multiple interfaces may also be used.

The memory 1564 stores information within the computing device 1550. The memory 1564 can be implemented as one or more of a computer-readable medium or media, a volatile memory unit or units, or a non-volatile memory unit or units. Expansion memory 1574 may also be provided and connected to device 1550 through expansion interface 1572, which may include, for example, a SIMM (Single In Line Memory Module) card interface. Such expansion memory 1574 may provide extra storage space for device 1550, or may also store applications or other information for device 1550. Specifically, expansion memory 1574 may include instructions to carry out or supplement the processes described above, and may include secure information also. Thus, for example, expansion memory 1574 may be provided as a security module for device 1550, and may be programmed with instructions that permit secure use of device 1550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1564, expansion memory 1574, or memory on processor 1552 that may be received, for example, over transceiver 1568 or external interface 1562.

Device 1550 may communicate wirelessly through communication interface 1566, which may include digital signal processing circuitry where necessary. Communication interface 1566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 1568. In addition, short-range communication may occur, such as using a BLUETOOTH, Wi-Fi, or other such transceiver (not shown). In addition, GPS (Global Positioning System) receiver module 1570 may provide additional navigation- and location-related wireless data to device 1550, which may be used as appropriate by applications running on device 1550.

Device 1550 may also communicate audibly using audio codec 1560, which may receive spoken information from a user and convert it to usable digital information. Audio codec 1560 may likewise generate audible sound for a user, such as through a speaker, e.g., in a handset of device 1550. Such sound may include sound from voice telephone calls, may include recorded sound (e.g., voice messages, music files, etc.) and may also include sound generated by applications operating on device 1550.

The computing device 1550 may be implemented in a number of different forms, as shown in the figure. For example, it may be implemented as a cellular telephone 1580. It may also be implemented as part of a smart phone 1582, personal digital assistant, tablet, wearable 1590, or another similar mobile device.

In some implementations, the computing devices depicted in the figure can include sensors that interface with a wearable (e.g., AR headset/HMD) device 1590 to generate an augmented environment for viewing inserted content within the physical space. For example, one or more sensors included on a computing device 1550 or other computing device depicted in the figure, can provide input to the wearable device 1590 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 1550 can use the sensors to determine an absolute position and/or a detected rotation of the computing device in the AR space that can then be used as input to the AR space. For example, the computing device 1550 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connected to, the computing device 1550 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 1550 when the computing device is incorporated into the AR space can cause a particular action to occur in the AR space.

In some implementations, a touchscreen of the computing device 1550 can be rendered as a touchpad in AR space. A user can interact with the touchscreen of the computing device 1550. The interactions are rendered, in wearable device 1590 for example, as movements on the rendered touchpad in the AR space. The rendered movements can control virtual objects in the AR space.

In some implementations, one or more output devices included on the computing device 1550 can provide output and/or feedback to a user of the wearable device 1590 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example computer-implemented methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

According to an aspect, a computer-implemented comprises determining that a user of the computing device has not blocked and has not allowed a resource permission requested by a website, obtaining a permission score for the resource from a model, the permission score representing a likelihood of the user allowing use of the resource, selecting a permissions interface element from one of a loud user interface element, a quiet user interface element, and an intermediate user interface element based on the permission score, and generating a user interface on a display of the computing device that includes the selected permissions interface element.

These and other aspects can include one or more of the following, alone or in combination. For example, the model may use features about the website and/or features about the user's past actions on permission prompts to generate the likelihood. As another example, the loud user interface element can occupy more area of the display when displayed than the intermediate user interface element, and the intermediate user interface element can occupy more area of the display when displayed than the quiet user interface element. As another example, the intermediate user interface element and the loud user interface element can include a selectable area for allowing the resource permission. As another example, the intermediate user interface element can be an animated element. The animation may cause at least one other browser-based user interface element to shrink in size at least temporarily. As another example, the loud user interface element may overlay at least some content of the website when displayed and the intermediate user interface element may, when displayed, share an area of the display previously occupied by at least one browser-based user interface element. As another example, the computer-implemented method of claim 1, wherein the quiet user interface element, as displayed, may be initially an icon without text and the intermediate user interface element, as displayed, may initially be an icon with text. In some such implementations, placement of the intermediate user interface element can be based on a reading direction. As another example, the model may take as input a form factor of the computing device, aggregate statistics representing number of times the resource permission is blocked, aggregate statistics representing number of times the resource permission is allowed, and/or user-based statistics relating to the resource permission for the user of the computing device. As another example, the intermediate user interface element can include a selectable element that initiates a privacy settings user interface.

In some aspects, the techniques described herein relate to a computer-implemented method performed on a computing device, the computer-implemented method including: determining that a user of the computing device has not blocked a permission for a resource and has not allowed the permission for the resource, the permission for the resource being requested by a website; obtaining a permission score for the resource from a model, the permission score representing a likelihood of the user allowing use of the resource; selecting a permissions interface element from one of a loud user interface element, a quiet user interface element, and an intermediate user interface element based on the permission score; and generating a user interface on a display of the computing device that includes the permissions interface element.

These and other aspects can include one or more of the following, alone or in combination. For example, the model may use features about the website and features about past actions of the user on permission prompts to generate the likelihood. As another example, the model may use features about past actions of the user on permission prompts to generate the likelihood. In another example, the model may use features about the website to generate the likelihood. In another example, the loud user interface element occupies more area of the display when displayed than the intermediate user interface element, and the intermediate user interface element occupies more area of the display when displayed than the quiet user interface element. In another example, the intermediate user interface element and the loud user interface element include a selectable area for allowing the permission for the resource. In another example, the intermediate user interface element is an animated element that causes at least one other browser-based user interface element to at least temporarily be displaced. In another example, when displayed, the loud user interface element overlays at least some content of the website and the intermediate user interface element shares an area of the display previously occupied by at least one browser-based user interface element. In another example, when displayed, the quiet user interface element is initially an icon without text and the intermediate user interface element is initially an icon with text. In another example, placement of the intermediate user interface element is based on a reading direction. In another example, the model may take as input a form factor of the computing device, aggregate statistics representing number of times the permission for the resource is blocked, aggregate statistics representing number of times the permission for the resource is allowed, and user-based statistics relating to the permission for the resource for the user of the computing device. In another example, the intermediate user interface element includes a selectable element that initiates a privacy settings user interface.

In some aspects, the techniques described herein relate to a computing device including: at least one processor; and memory storing instructions that, when executed by the at least one processor, causes the computing device to perform operations including: determining that a user of the computing device has not blocked a permission for a resource and has not allowed the permission for the resource, the permission for the resource being requested by a website, obtaining a permission score for the resource from a model, the permission score representing a likelihood of the user allowing use of the resource, selecting a permissions interface element from one of a first user interface element, a second user interface element, and a third user interface element based on the permission score, and generating a user interface on a display of the computing device that includes the permissions interface element.

These and other aspects can include one or more of the following, alone or in combination. For example, to generate the likelihood the model may use features about the website or features about past actions of the user on permission prompts. As another example, the first user interface element can occupy more area of the display when displayed than the second user interface element, and the second user interface element can occupy more area of the display when displayed than the third user interface element. As another example, the second user interface element can be an animated element that causes at least one other browser-based user interface element to at least temporarily be displaced. As another example, the first user interface element, when displayed, overlays at least some content of the website and the second user interface element, when displayed, shares an area of the display previously occupied by at least one browser-based user interface element. As another example, the third user interface element is initially an icon without text when displayed and the second user interface element, when displayed, is initially an icon with text. As another example, the model can take as input a form factor of the computing device, aggregate statistics representing number of times the permission for the resource is blocked, aggregate statistics representing number of times the permission for the resource is allowed, and user-based statistics relating to the permission for the resource for the user of the computing device. As another example, the second user interface element can include a selectable element that initiates a privacy settings user interface.

In one aspect, a non-transitory computer-readable medium stores instructions that, when executed by a processor on a receiving computing device, causes the receiving computing device to perform any of the methods disclosed herein.

In one aspect, a computing device can be configured with at least one processor and memory storing instructions that, when executed by the at least one processor, performs any of the methods disclosed herein.

1. A computer-implemented method performed on a computing device, the computer-implemented method comprising:
determining that a user of the computing device has not blocked a permission for a resource and has not allowed the permission for the resource, the permission for the resource being requested by a website;
obtaining a permission score for the resource from a model, the permission score representing a likelihood of the user allowing use of the resource;
selecting a permissions interface element from one of a loud user interface element, a quiet user interface element, and an intermediate user interface element based on the permission score; and
generating a user interface on a display of the computing device that includes the permissions interface element.

2. The computer-implemented method of claim 1, wherein the model uses features about the website and features about past actions of the user on permission prompts to generate the likelihood.

3. The computer-implemented method of claim 1, wherein the model uses features about past actions of the user on permission prompts to generate the likelihood.

4. The computer-implemented method of claim 1, wherein the model uses features about the website to generate the likelihood.

5. The computer-implemented method of claim 1, wherein the loud user interface element occupies more area of the display when displayed than the intermediate user interface element, and the intermediate user interface element occupies more area of the display when displayed than the quiet user interface element.

6. The computer-implemented method of claim 1, wherein the intermediate user interface element and the loud user interface element include a selectable area for allowing the permission for the resource.

7. The computer-implemented method of claim 1, wherein the intermediate user interface element is an animated element that causes at least one other browser-based user interface element to at least temporarily be displaced.

8. The computer-implemented method of claim 1, wherein when displayed the loud user interface element overlays at least some content of the website and the intermediate user interface element shares an area of the display previously occupied by at least one browser-based user interface element.

9. The computer-implemented method of claim 1, wherein when displayed the quiet user interface element is initially an icon without text and the intermediate user interface element is initially an icon with text.

10. The computer-implemented method of claim 9, wherein placement of the intermediate user interface element is based on a reading direction.

11. The computer-implemented method of claim 1, wherein the model takes as input a form factor of the computing device, aggregate statistics representing number of times the permission for the resource is blocked, aggregate statistics representing number of times the permission for the resource is allowed, and user-based statistics relating to the permission for the resource for the user of the computing device.

12. The computer-implemented method of claim 1, wherein the intermediate user interface element includes a selectable element that initiates a privacy settings user interface.

13. A computing device comprising:
at least one processor; and
memory storing instructions that, when executed by the at least one processor, causes the computing device to perform operations including:
determining that a user of the computing device has not blocked a permission for a resource and has not allowed the permission for the resource, the permission for the resource being requested by a website,
obtaining a permission score for the resource from a model, the permission score representing a likelihood of the user allowing use of the resource,
selecting a permissions interface element from one of a first user interface element, a second user interface element, and a third user interface element based on the permission score, and
generating a user interface on a display of the computing device that includes the permissions interface element.

14. The computing device of claim 13, wherein to generate the likelihood the model uses features about the website or features about past actions of the user on permission prompts.

15. The computing device of claim 13, wherein the first user interface element occupies more area of the display when displayed than the second user interface element, and the second user interface element occupies more area of the display when displayed than the third user interface element.

16. The computing device of claim 13, wherein the second user interface element is an animated element that causes at least one other browser-based user interface element to at least temporarily be displaced.

17. The computing device of claim 13, wherein when displayed the first user interface element overlays at least some content of the website and the second user interface element shares an area of the display previously occupied by at least one browser-based user interface element.

18. The computing device of claim 13, wherein when displayed the third user interface element is initially an icon without text and the second user interface element is initially an icon with text.

19. The computing device of claim 13, wherein the model takes as input a form factor of the computing device, aggregate statistics representing number of times the permission for the resource is blocked, aggregate statistics representing number of times the permission for the resource is allowed, and user-based statistics relating to the permission for the resource for the user of the computing device.

20. The computing device of claim 13, wherein the second user interface element includes a selectable element that initiates a privacy settings user interface.
